(19) United States
(12) Patent Application Publication
(10) Pub. No.: US 2010/0269624 A1
(43) Pub. Date: Oct. 28, 2010

(54) SUPPLEMENTAL HANDLEBAR FOR A HANDLEBAR CONTROLLED VEHICLE

(76) Inventors: Kevin Price, Reno, NV (US); Jeffery Owens, Reno, NV (US)

Correspondence Address: Kenneth Bower, 314 Ironstone Lane, Elverson, PA, 19520, US

(21) Appl. No.: 12/768,019

(22) Filed: Apr. 27, 2010

Related U.S. Application Data
(60) Provisional application No. 61/172,925, filed on Apr. 27, 2009.

(51) Int. Cl. B62K 21/12

(52) U.S. Cl. 74/551.8

(57) ABSTRACT

The present invention is a supplemental handlebar for a handlebar controlled vehicle with a primary handlebar for a user and an optional additional user. The supplemental handlebar has an intermediate tube that is a base for the supplemental handlebar and a two piece clamp for attaching the supplemental handlebar and the intermediate tube to the primary handlebar using a plurality of bolts and screws and a handlebar extension. A handle and handle shield are adjustably attached to each end of the handlebar extension with a split tube coupling and a corresponding bolt. This unique design allows for independent adjustment of the lateral position, height and the angle of the axis of the grip and hand shield for optimization of the safety and comfort of the passenger which can include small children.

### CROSS-REFERENCE TO RELATED APPLICATIONS

This application claims priority to U.S. Provisional Application 61/172,925 filed on Apr. 27, 2009, the entire disclosure of which is incorporated by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

The adventurous teenage risk taker that fell in love with all terrain vehicles (ATVs), mud bikes and variations of “between the legs or handlebar controlled” vehicles is now an adult. Many of them are raising families of their own but have not set aside the motorized vehicle toys they so enjoyed in their youth. Couples that met in motorcycle clubs, ATV meets and while out for a joy ride are now married and are also raising kids. Out of this phenomenon is emerging a rapidly growing generation of families that want to enjoy the outdoors together on their parent's motorized vehicle toys.

While small versions of these “between the legs or handlebar controlled” vehicles are available for larger children, there is a need to prepare younger kids not yet capable of controlling a vehicle by themselves for driving a vehicle in the future. Altering an existing ATV, motorcycle, bicycle or other handlebar controlled device for a younger child is a logical approach to satisfying this need. Products that add a second handlebar to an existing handlebar controlled vehicle have been showing up on store shelves, however each of these products only fit on a small subset of the handlebar controlled vehicle configurations that are in the market.

### PRIOR ART

U.S. Pat. No. 5,429,013 issued to Taylor et al. on Feb. 27, 1992, describes climbing handles for road bicycles that serve as a supplemental handlebar for a handlebar controlled vehicle, having a vertical adjustment range extending below the vertical level of the primary handlebars, and has two independently adjustable sections, that adjust at the attachment point to the arm length of the rider. Taylor lacks attachment means to the essentially vertical portion of the handlebars on an ATV, Taylor further lacks independent adjustments for the height of the supplemental handlebars and the lateral adjustment to adapt to the rider's arm length. Taylor finally lacks an additional angular adjustment of the grip and hand shield to provide for optimized rider comfort.

U.S. Pat. No. D 488,745 issued to Rondeau, et al. on Feb. 26, 2002, describes an ornamental design for a portion of an all terrain vehicle that teaches the essentially vertical portion of the handlebars used for attachment of the supplemental handlebar of the present invention. Rondeau lacks a teaching of the remaining features of the present invention because it lacks supplemental handlebars.

U.S. Pat. No. 599,564 issued to Kintner on Feb. 22, 1898, describes a plurality of detachable handles for handles to be attached to handles bars at preferred points that can serve as a supplemental handlebar for a handlebar controlled vehicle, having a vertical adjustment range extending below the vertical level of the primary handlebars (un-shown), and has two independently adjustable sections, that adjust laterally at the attachment point to the arm length of the rider. Kintner lacks attachment means to the essentially vertical portion of the handlebars on an ATV. Taylor further lacks independent adjustments for the height of the supplemental handlebars and the lateral adjustment to adapt to the rider's arm length. Taylor finally lacks an additional angular adjustment of the grip and hand shield to provide for optimized rider comfort.

U.S. Pat. No. 7,143,662 issued to Hobson, Jr. on May 18, 2005, describes cruiser bars for motorcycle handlebars that can serve as a supplemental handlebar for a handlebar controlled vehicle, having a vertical adjustment range extending below the vertical level of the primary handlebars (un-shown), and has two independently adjustable sections that adjust laterally at the attachment point to the arm length of the rider. Hobson, Jr. lacks attachment means to the essentially vertical portion of the handlebars on an ATV. Hobson, Jr., finally lacks an additional angular adjustment of the grip and hand shield to provide for optimized rider comfort.

None of the above patents or Published patent applications singly or in combination is seen to describe the present invention as claimed.

### BRIEF SUMMARY OF THE INVENTION

The present invention generally relates to a supplemental handlebar for a handlebar controlled vehicle. More specifically, the invention is a supplemental handlebar for a handlebar controlled vehicle that can be used with motorcycles, all terrain vehicles (ATV), snowmobiles, jet skis and other handlebar controlled vehicles.

It is an object of the present invention to provide a supplemental handlebar for a handlebar controlled vehicle

It is another object of the present invention is to provide a supplemental handlebar that; attaches to the essentially vertical portion of the handlebars found on most all terrain vehicles;

a further object of the present invention is to provide supplemental handlebars that adjust in a range that extends below the vertical level of the primary handlebars of the handlebar controlled vehicle;

a further object of the present invention is to provide supplemental handlebars provided in two separate sections where each section adjusts independently of the other section;

a further object of the present invention is to adjust each section of the supplemental handlebar at the attachment point with the primary handlebars to adapt the supplemental handlebars to the arm length of the rider;

a further object of the present invention is to provide separate adjustment of the height of the supplemental handlebars from the angular adjustment adapting to the length of the rider's arms;

a final object of the present invention is to adjust the axis of the grip and hand shield independently for optimizing comfortable use by a wide spectrum of user and child imposed geometries.

### BRIEF DESCRIPTION OF THE SEVERAL VIEWS OF THE DRAWING(S)

The present invention will be described by way of exemplary embodiments, but not limitations, illustrated in the accompanying drawing in which like references denote similar elements, and in which:

FIG. 1: illustrates an environmental perspective view of a supplemental handle bar for a handle bar controlled vehicle used by a user and a child, in combination with an ATV.

FIG. 2: illustrates an exploded diagonal side perspective view of a supplemental handle bar for a handle bar controlled vehicle.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation. The terms “comprising”, “having” and “including” are synonymous, unless the context dictates otherwise.

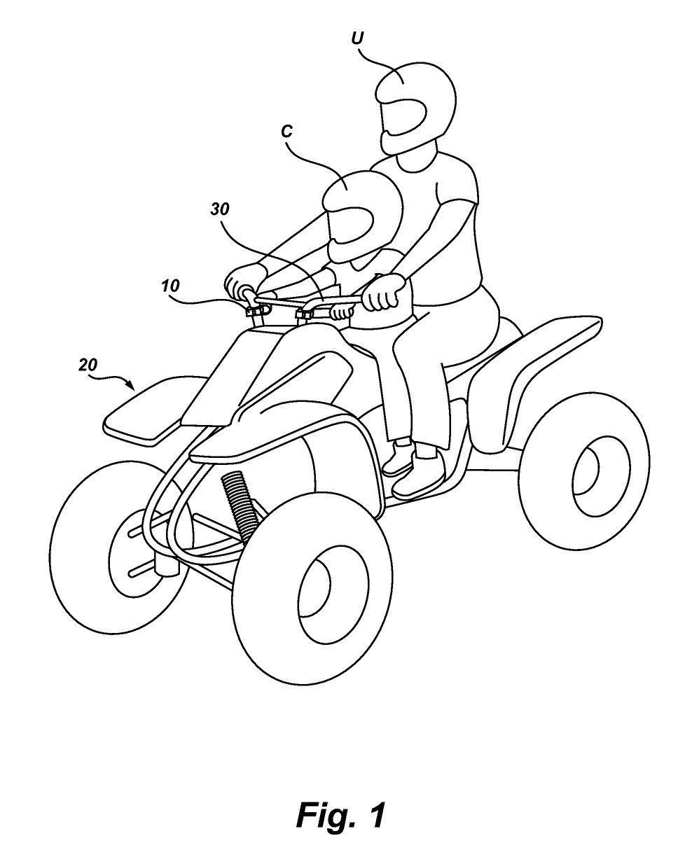

FIG. 1 illustrates an environmental perspective view of a supplemental handlebar for a handlebar controlled vehicle 10 used by a user U or passenger and an additional user or driver, such as a child C, in combination with a handlebar controlled vehicle 20, such as an ATV and its primary handlebars 30. The supplemental handlebar for a handlebar controlled vehicle 10 can be used with motorcycles, bicycles, snowmobiles, jet skis and other handlebar controlled devices that are well known to those skilled in the art. The supplemental handlebar for a handlebar controlled vehicle 10 can provide a second gripping source for a user U or any additional rider or driver, such as a child C, for gripping to supplement a primary handlebar 30. The supplemental handlebar for a handlebar controlled vehicle 10 can also provide a user U and/or a child C with improved erect posture and a relaxed arm posture while a user U and/or a child C are gripping the supplemental handlebar for a handlebar controlled vehicle 10.

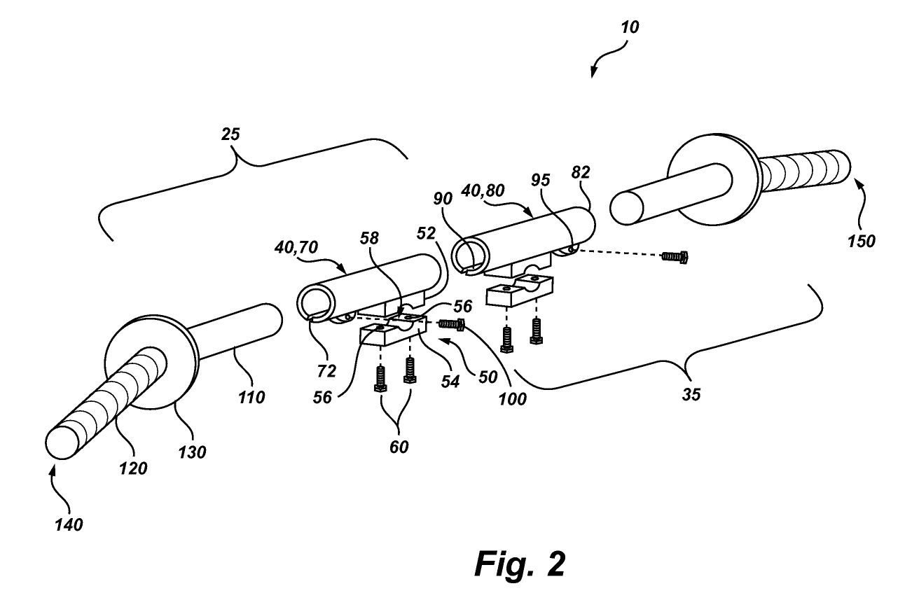

FIG. 2 illustrates an exploded diagonal side perspective view of a supplemental handlebar for a handlebar controlled vehicle 10. The supplemental handlebar for a handlebar controlled vehicle 10 may be installed by the manufacturer of the vehicle with a handle, installed as a kit by a vehicle dealer or sold separately for installation by a user U or a mechanic on an existing handlebar controlled vehicle 20. To install the supplemental handlebar for a handlebar controlled vehicle 10, an intermediate tube 40 located on each side 25, 35 of the supplemental handlebar for a handlebar controlled vehicle 10 is attached to the primary handlebar 30 by a two piece clamp 50 with a top portion 52 and a bottom portion 54 with a plurality of apertures 56 extending through the bottom portion 54 and a plurality of accommodating clamp screws or bolts 60. The two clamp portions 52, 54 form a semi-circular area 58 that is accommodated by the primary handlebars 30 when the plurality of screws or bolts 60 are extended through the two clamp portions 52, 54 and into the primary handlebars 30 and top portion 52, forming an attachment to the primary handlebars 30.

The left side intermediate tube 70 has a distal end 72 and a proximal end 74 and the right side intermediate tube 80 has a distal end 82 and a proximal end 84. The proximal end of the left side 74 and the proximal end of the right side of the intermediate tube 84 are one continuous piece of the supplemental handlebar for a handlebar controlled vehicle 10 and are separated and exploded for illustrative purposes only. In other words, the left side of the intermediate tube 70 and the right side of the intermediate tube 80 form one continuous single intermediate tube 40. Both the distal ends 72, 82 of the supplemental handlebar for a handlebar controlled vehicle 10 have a split tube coupling 90 and an aperture 95 and a corresponding bolt 100. A handlebar extension 110 is inserted into each split end coupling 90 that can be adjusted and moved within the distal end 72, 82 to provide an adjustable comfortable arm position for a user U and/or a child C while holding or maneuvering the supplemental handlebar for a handlebar controlled vehicle 10. The corresponding bolt 100 is also tightened to secure the supplemental handlebar for a handlebar controlled vehicle 10 in place once a comfortable and desirable length is achieved. There is also a handle 120 and a handle shield 130 on each end 140, 150 of the supplemental handlebar for a handlebar controlled vehicle 10 that extends from each handle extension 110. The handle 120 and the handle shield 130 are designed for a user U and/or a child C to securely grip and grasp the supplemental handlebar for a handlebar controlled vehicle 10. The handle shields 130 keep the user's U and/or the child's C hands from slipping onto the handlebar extension 110 to assist in maintaining good balance as well as improving the user's U and/or the child's C grip on the supplemental handlebar for a handlebar controlled vehicle 10. The handle 120 also has a surface gripping material and design that can be any gripping material that is well known in the art to further enhance gripping ability. The handle 120 may also be angularly turned into the split tube coupling 90, prior to tightening the bolt 100 to adapt to the geometry of the user's U and/or the child's C arms. The horizontal axis of the supplemental handlebar for a handlebar controlled vehicle 10 is set at an approximate 30° angle from the horizontal axis of the handlebar extension 110, although this angle may vary between 0° and 90° and be adjustable to adapt to extreme handlebar or user or child imposed geometries.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A supplemental handlebar for use by a passenger on a handlebar controlled vehicle by attachment to a primary handlebar for use by a driver of said handlebar controlled vehicle, comprising:
a left and a right intermediate tube each with a proximal end and a distal end, and with a split tube coupling at said distal end, that are adapted for engagement with a first one or more fasteners, said left and right intermediate tubes for forming a base for said supplemental handlebars;
one or more two piece clamps with a top portion and a bottom portion for attaching said left hand and right hand intermediate tubes to said primary handlebars, said top portion and said bottom portion adapted for engagement with a second one or more fasteners;
a left and a right handlebar extension each with a first end and a second end and said first end for attachment to said distal end of said left and said right intermediate tubes; and
a hand grip and a hand shield that are attached to the second end of said left and said right handlebar extensions for said passenger to grasp as said driver maneuvers said vehicle.

2. Said supplemental handlebar according to claim 1, wherein said hand grip and said hand shield can be adjusted to a vertical position below a vertical level of said handlebar grips of said primary handlebars.

3. Said supplemental handlebar according to claim 1, wherein said first portion and said second portion of said two piece clamps are adapted for engagement with a second one or more fasteners to an essentially vertical portion of said primary handlebars.

4. Said supplemental handlebar according to claim 1, wherein an angular relationship between said left and right intermediate tube is made by adjustment of said two piece clamps on said essentially vertical portion of said primary handlebars.

5. Said supplemental handlebar according to claim 1, wherein said second end of said left and said right handlebar extensions has an angular relationship to said first end of said left and said right handlebar extensions;

6. Said supplemental handlebars according to claim 1, wherein said second end of said left and said right handlebar extensions has an angular relationship to said primary handlebar that is adjustable at said split tube clamp for ergonomic comfort.

7. A supplemental handlebar for use by a passenger on a handlebar controlled vehicle by attachment to a primary handlebars for use by a driver of said handlebar controlled vehicle, comprising:
a left and a right intermediate tube each with a proximal end and a distal end, and with a split tube coupling at said distal end, that are adapted for engagement with a first one or more fasteners, said left and right intermediate tubes for forming a base for said supplemental handlebars, one or more two piece clamps with a top portion and a bottom portion for attaching said left hand and right hand intermediate tubes, said first portion and said second portion adapted for engagement with a second one or more fasteners;
a left and a right handlebar extension each with a first end and a second end and said first end for attachment to said distal end of said left and said right intermediate tubes;
a hand grip and a hand shield that are attached to said second end of said left and said right handlebar extensions for said passenger to grasp as said driver maneuvers said vehicle; and
wherein said hand grip and said hand shield can be adjusted to a vertical position below a vertical level of a handlebar grips of said primary handlebars.

8. Said supplemental handlebar according to claim 7, wherein said first portion and said second portion of said two piece clamps are adapted for engagement with a second one or more fasteners to an essentially vertical portion of said primary handlebars.

9. Said supplemental handlebar according to claim 7, wherein an angular relationship between said left and right intermediate tube is made by adjustment of said two piece clamps on said essentially vertical portion of said primary handlebars.

10. Said supplemental handlebar according to claim 7, wherein said second end of said left and said right handlebar extensions has an angular relationship to said first end of said left and said right handlebar extensions.

11. Said supplemental handlebar according to claim 7, wherein said second end of said left and said right handlebar extensions has an angular relationship to said primary handlebar that is adjustable at said split tube clamp for ergonomic comfort.

12. A supplemental handlebar for use by a passenger on a handlebar controlled vehicle by attachment to a primary handlebars for use by a driver of said handlebar controlled vehicle, comprising:
a left and a right intermediate tube each with a proximal end and a distal end, and with a split tube coupling at said distal end, that are adapted for engagement with a first one or more fasteners, said left and right intermediate tubes for forming a base for said supplemental handlebars;
one or more two piece clamps with a top portion and a bottom portion for attaching said left hand and right hand intermediate tubes, said first portion and said second portion adapted for engagement with a second one or more fasteners;
a left and a right handlebar extension each with a first end and a second end and said first end for attachment to said distal end of said left and said right intermediate tubes;
a hand grip and a hand shield that are attached to said second end of said left and said right handlebar extensions for said passenger to grasp as said driver maneuvers said vehicle;
wherein said hand grip and said hand shield can be adjusted to a vertical position below a vertical level of a handlebar grips of said primary handlebars; and
wherein said first portion and said second portion of said two piece clamps are adapted for engagement with a second one or more fasteners to an essentially vertical portion of said primary handlebars.

13. Said supplemental handlebar according to claim 12, wherein an angular relationship between said left and right intermediate tube is made by adjustment of said two piece clamps on said essentially vertical portion of said primary handlebars.

14. Said supplemental handlebar according to claim 12, wherein said second end of said left and said right handlebar extensions has an angular relationship to said first end of said left and said right handlebar extensions.

15. Said supplemental handlebar according to claim 12, wherein said second end of said left and said right handlebar extensions has an angular relationship to said primary handlebar that is adjustable at said split tube clamp for ergonomic comfort.
